(19) United States
(12) Patent Application Publication
(10) Pub. No.: US 2013/0067249 A1
(43) Pub. Date: Mar. 14, 2013

(54) CONTROL SYSTEM FOR POWER ON AND OFF COMPUTER

(71) Applicants: JIAN ZHAO, Wuhan City (CN); ZHONG-GANG WU, Wuhan City (CN)

(72) Inventors: JIAN ZHAO, Wuhan City (CN); ZHONG-GANG WU, Wuhan City (CN)

(73) Assignees: HON HAI PRECISION INDUSTRY CO., LTD., Tu-Cheng (TW); HONG FU JIN PRECISION INDUSTRY (WUHAN) CO., LTD., Wuhan City (CN)

(21) Appl. No.: 13/534,376

(22) Filed: Jun. 27, 2012

(30) Foreign Application Priority Data
Sep. 8, 2011 (CN) 201110265614.9

(51) Int. Cl. G06F 1/00

(52) U.S. Cl. 713/300

(57) ABSTRACT

A control system includes an input module, a control module, a switch module and a display module. The input module is configured to output test parameters to the control module. The control module is capable of outputting power on and power off control signals according to the test parameters. The switch module is capable of receiving the power on and power off control signals and is configured to output the signals to power a computer motherboard on or off accordingly. The computer motherboard is configured to output feedback signals to the control module after being successfully powered on. The control module displays test results on the display module according to the feedback signals.

### BACKGROUND

1. Technical Field

The present disclosure relates to control systems, and particularly to a control system for controlling power on and off computer.

2. Description of Related Art

During a computer motherboard power on/off test, a DC power on/off test is important. A tester may press the voltage button to power on or off the computer motherboard. When the voltage button is pressed, the voltage button sends a low potential signal to an input and output controller of the computer motherboard. When the voltage button is released, the input and output controller is reset to a high potential. The computer is powered on to execute test procedure until the tester switches off the computer using the software. Repeating power on/off operating and the test is carried out until the number of times powered on/off is up to a preset value. It is time-consuming and laborious to accomplish the test task.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a control system.

FIG. 2 is a circuit view of a control module and a display module.

FIG. 3 is a circuit view of a switch module and an indication module.

FIG. 4 is a circuit view of a backlight control circuit.

FIG. 5 is a circuit view of an alarm module.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

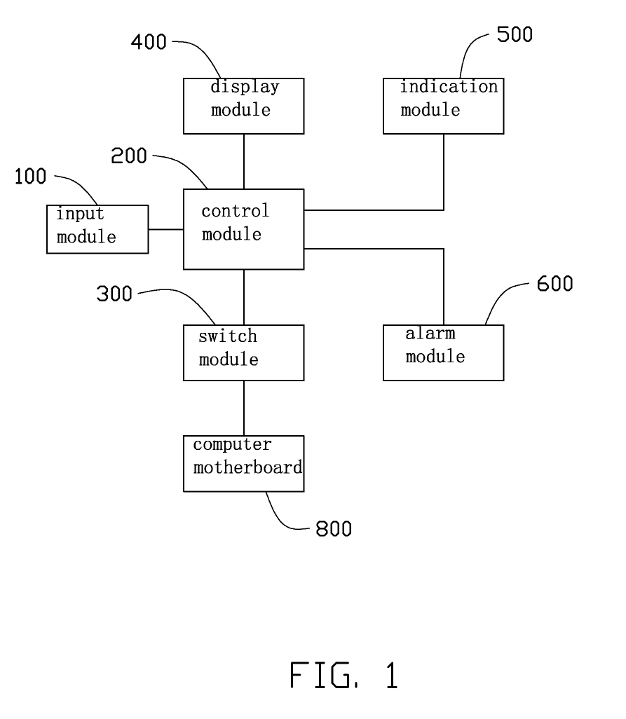

Referring to FIG. 1, a control system of an embodiment includes an input module 100, a control module 200, a switch module 300, a display module 400, an indication module 500, and an alarm module 600. The input module 100 inputs test parameters to the control module 200. The control module 200 outputs power on and power off control signals according to the test parameters. The switch module 300 receives the power on or power off control signals to power on or off a computer motherboard 800. The computer motherboard 800 outputs feedback signals to the control module 200 after the computer motherboard 800 is powered on. The control module 200 is capable of displaying test results on the display module 400 according to the feedback signals. During the test procedure, the indication module 500 indicates that the computer motherboard 800 is powered on. The alarm module 600 is activated when the computer motherboard 800 cannot be powered on .

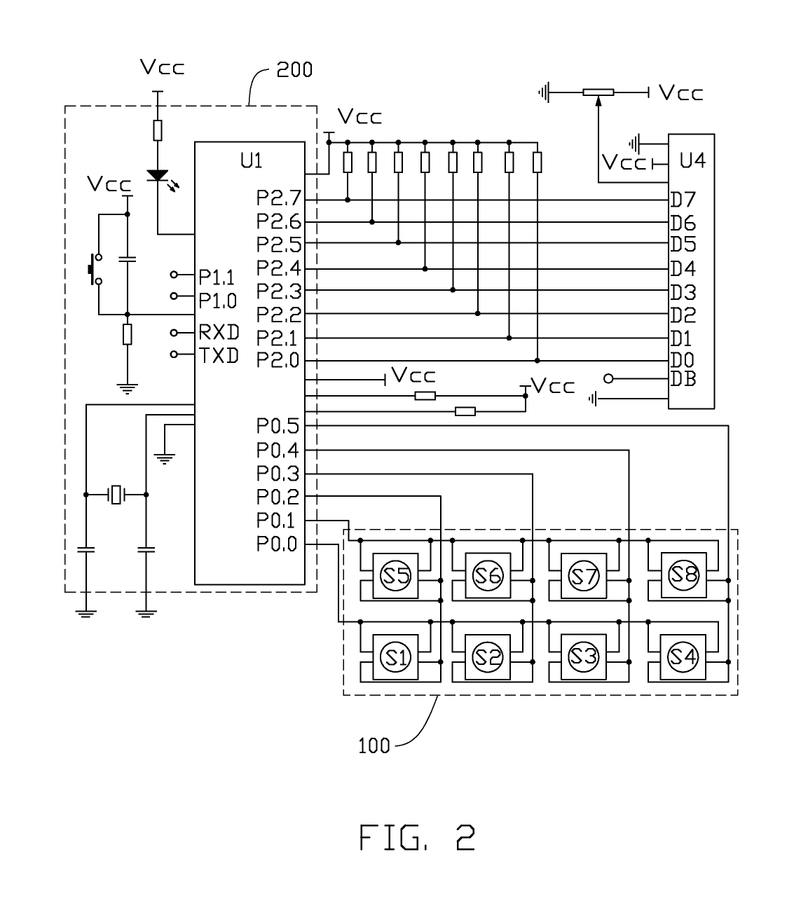

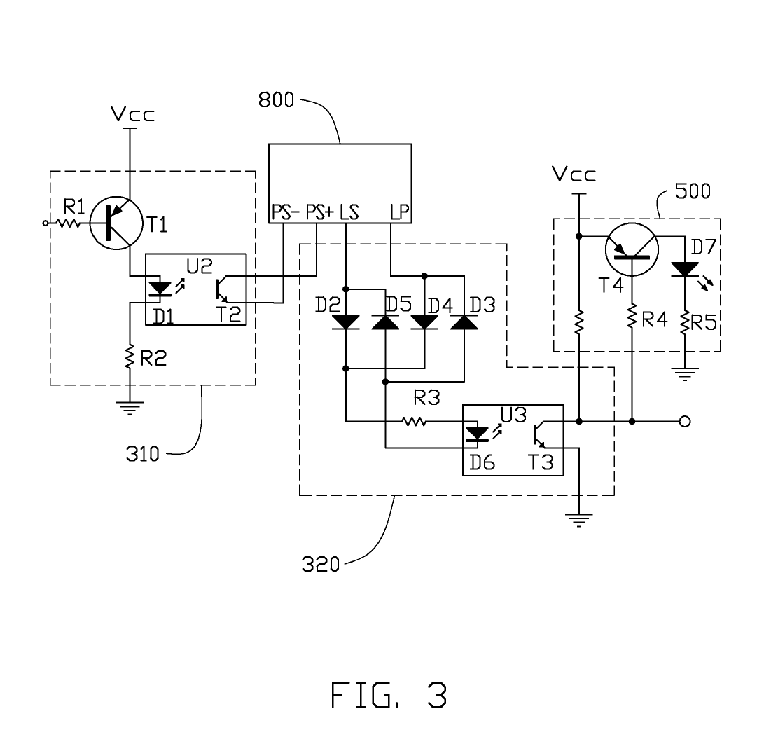

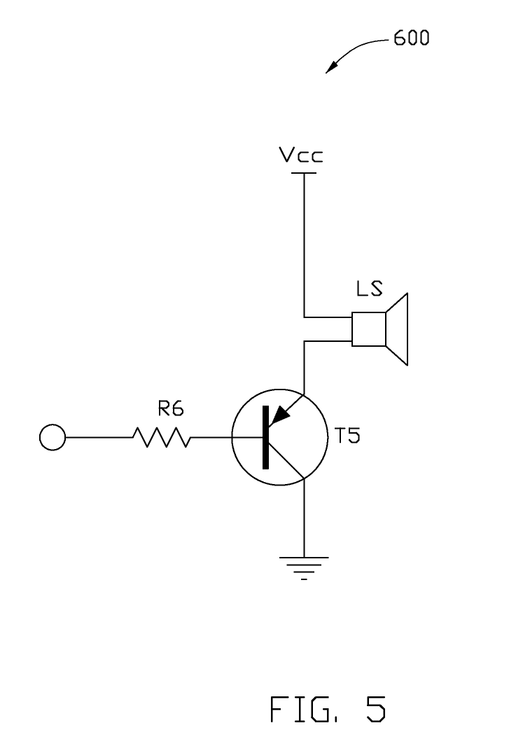

Referring to FIGS. 2-5, the input module 100 includes a plurality of button switches S1˜S8. Each of the plurality of button switches S1˜S8 includes a first input, a second input, a third output, and a fourth output. The control module 200 includes a microcontroller U1. The micro controller U1 includes a plurality of test signal input terminals P0.0˜P0.5, a control signal sending terminal RXD, a feedback signal receiving terminal TXD, an alarm signal output terminal P1.0, a backlight control signal output terminal P1.1, and a plurality of data signal output terminals P2.0˜P2.7. The first input and the second input of the button switches S1˜S4 are electronically connected to the test signal input terminal P0.0. The first input and the second input of the button switches S5˜S8 are electronically connected to the test signal input P0.1. The third input and the fourth input of the button switches S1 and S5 are electronically connected to the test signal input terminal P0.2. The third input and the fourth input of the button switches S2 and S6 are electronically connected to the test signal input terminal P0.3. The third input and the fourth input of the button switches S3 and S7 are electronically connected to the test signal input terminal P0.4. The third input and the fourth input of the button switches S4 and S8 are electronically connected to the test signal input terminal P0.2. The plurality of button switches S1˜S8 input test parameters to the test signal input terminals P0.0˜P0.5.

The switch module 300 includes a switch circuit 310 and a feedback circuit 320. The switch circuit 310 includes a first triode T1 and a photoelectric coupler U2. The photoelectric coupler U2 includes a first light-emitting unit D1 and a first photosensitive element T2. A base of the first triode T1 is electronically connected to the control signal sending terminal RXD via a first resistance R1 to receive control signals. The first triode T1 emitter receives a DC voltage VCC. The first triode T1 collector is grounded via the first light-emitting unit D1 and a second resistance R2. One terminal of the second resistance R2 is grounded, and another terminal of the second resistance R2 is connected to the first light-emitting unit D1. The ends of the first photosensitive element T2 are electronically connected to a voltage pin PS+and a grounded pin PS- of the computer motherboard 800 respectively.

The feedback circuit 320 includes a first diode D2, a second diode D3, a third diode D4, a fourth diode D5 and a second photoelectric coupler U3. The second photoelectric coupler U3 includes a light-emitting unit D6 and a second photosensitive element T3. The first diode D2 anode is electronically connected to an anode pin LS of the computer motherboard 800. The first diode D2 cathode is electronically connected to the second diode D3 anode and the fourth diode D5 via a third resistance R3 and a second light-emitting unit D6. The second diode D3 cathode is electronically connected to an electrode pin LP of the computer motherboard 800. The fourth diode D5 cathode is electronically connected to an anode pin LS. The second photosensitive element T3 is electronically connected to the feedback signal receiving terminal TXD. The third diode D4 anode is electronically connected to the cathode pin LP. The third diode D4 cathode electronically connected to the first diode D2 anode.

The indication module 500 includes a second triode T4 and a light-emitting diode D7. The second triode T4 base is electronically connected to a first end of the second photoelectric coupler U3 via a fourth resistance R4. A second end of the second photoelectric coupler U3 is grounded. The second triode T4 emitter receives the DC voltage VCC. The second triode T4 collector is grounded via a light-emitting diode D7 and a third resistance R5.

Referring to FIG. 6, the alarm module 600 includes a third triode T5 and a buzzer LS. The third triode T5 base is electronically connected to the alarm signal output terminal P1.0 via a sixth resistance R6. The third triode T5 emitter receives the

DC voltage VCC via the buzzer LS and the third triode T5 collector is grounded.

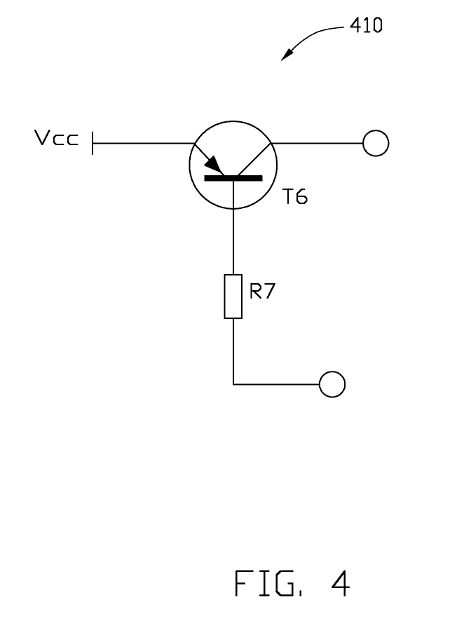

The display module 400 includes a liquid crystal display panel U4 (not shown) and a backlight control circuit 410 (shown in FIG. 4). The liquid crystal display panel U4 includes a plurality of data signal input terminals D0˜D7 and a backlight signal output terminal DB. Each data signal output terminals P2.0˜P2.7 is electronically connected to each of the data signal input terminals D0˜D7 to output test results.

Referring to FIG. 4, the backlight control circuit 410 includes a fourth triode T6. The fourth triode T6 base is electronically connected to the backlight control signal output terminal P1.1 via a seventh resistance R7. The fourth triode T6 emitter receives a DC voltage VCC. The fourth triode T6 collector is electrically connected to the backlight signal output terminal DB.

In use, the button switches S1˜S8 are switched on to output a total number of cycle times, boot time and power off time of the computer motherboard 800, to the micro controller U1. The micro controller U1 sends a low potential to be the first triode T1. The first light-emitting unit D1 emits light to be the first photosensitive element T2. The voltage pin PS+ is instantly connected to the grounded pin PS− to cause the computer motherboard 800 to boot the computer motherboard 800. When boot time of the computer motherboard 800 reaches the preset time, the micro controller U1 continually sends a low potential to the first triode T1. The first light-emitting unit D1 emits light to be the first photosensitive element T2. The voltage pin PS+has a constant connection to the ground pin PS− to break and power off the computer motherboard 800. The micro controller U1 continually sends a low potential to control the computer motherboard 800 to power on or power off, and the micro controller U1 records the number of cycles, boot time and power off time. When the number of times powered on and powered off reaches the preset number, the micro controller U1 stops sending the low potential control signals to the first triode T1. The micro controller U1 outputs the test results displayed on the liquid crystal display panel U4 via the data signal outputs terminals P2.0˜P2.7.

In the test procedure, after the computer motherboard 800 is powered on successfully, the anode pin LS sends a high potential to the second light-emitting unit D6. The second light-emitting unit D6 works to conduct the second photosensitive element T3. The second photosensitive element T3 works to conduct the second triode T4. The light-emitting diode D7 receives the DC voltage VCC. The micro controller U1 sends a low potential backlight control signal to conduct the fourth triode T6 via the backlight control signal input P1.1. The backlight control input terminal DB of the liquid crystal display panel U4 receives the DC voltage VCC. The first diode D2, the second diode D3, the third diode D4 and the fourth diode D5 are configured to protect the control system. When the control system has a positive connection with the voltage pin PS+ and the ground pin PS−, the computer motherboard 800 causes the first light-emitting unit D1 to conduct via the first diode D2 and the second diode D3. When control system has a reverse connection with the voltage pin PS+ and the ground pin PS−, the computer motherboard 800 causes the first light-emitting unit D1 to conduct via the third diode D4 and the fourth diode D5.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A control system comprising:
an input module capable of inputting test parameters;
a control module capable of outputting power on or off control signals according to the rest parameters;
a switch module capable of receiving the power on or off control signals to power on or off a computer mother board accordingly; and
a display module;
wherein the computer motherboard is capable of outputting feedback signals to the control module after powered on, and the control module is capable of displaying test results on the display module according to the feedback signals.

2. The control system of claim 1, wherein the input module comprises a plurality of button switches, the control module comprises a micro controller, the micro controller comprises a plurality of test signal input terminals, and the plurality of button switches are electronically connected to the plurality of test signal input terminals to input the test parameters.

3. The control system of claim 2, wherein the micro controller further comprises a control signal sending terminal; the switch module comprise a switch circuit, the switch circuit comprises a first triode and a photoelectric coupler; the photoelectric coupler comprises a first light-emitting unit and a first photosensitive element; a base of the first triode is electronically connected to the control signal sending terminal via a first resistance to receive control signals, an emitter of the first triode receives a DC voltage and a collector of that is grounded via the first light-emitting unit and a second resistance; and two ends of the first photosensitive element are separately electronically connected to a voltage pin and a grounded pin of the computer motherboard.

4. The control system of claim 3, wherein the micro controller further comprises a feedback signal receiving terminal, the switch module further comprises a feedback circuit; the feedback circuit comprises a first diode, a second diode and a second photoelectric coupler; the second photoelectric coupler comprises a second light-emitting unit and a second photosensitive element; the first diode anode is electronically connected to the computer motherboard anode pin, the first diode cathode is electronically connected to the second diode anode via the second light-emitting unit; the second diode cathode is electronically connected to the computer motherboard cathode pin; and the second photosensitive element is electronically connected to the feedback signal receiving terminal

5. The control system of claim 4, wherein the feedback circuit further comprise a third diode and a fourth diode; the third diode anode is electronically connected to the computer motherboard cathode pin, the third diode cathode is electronically connected to the fourth diode anode via the second light-emitting unit; and the fourth diode cathode is electronically connected to the computer motherboard anode pin.

6. The control system of claim 4 further comprises an indication module, the indication module further comprises a second triode and a light-emitting diode; the second triode base is grounded via the second photoelectric coupler, and the second triode emitter is capable of receiving the DC voltage, and the second triode collector is grounded via the light-emitting diode.

7. The control system of claim 6 further comprises a alarm module, the alarm module comprises a third triode and a buzzer; the micro controller further comprises a alarm signal output terminal; the third triode base is electronically connected to the alarm signal output terminal, and the third triode emitter is capable of receiving the DC voltage via the buzzer, and the third triode collector that is grounded.

8. The control system of claim 7, wherein the micro controller further comprises a plurality of data signal output terminals; the display module comprises a liquid crystal display panel, the liquid crystal display panel comprises a plurality of data signal input terminals, and each of the plurality of data signal output terminals is electronically connected to each of the plurality of data signal input terminals to output test result.

9. The control system of claim 8, wherein the display module further comprises a backlight control circuit; the backlight control circuit comprises a fourth triode, the micro controller further comprises a backlight control signal output terminal, the liquid crystal display panel further comprises a backlight control signal input terminal; the fourth triode base is electronically connected to the backlight control signal output terminal, the fourth triode emitter is capable of receiving the DC voltage, and the fourth triode collector is electronically connected to the backlight control signal input terminal

10. A control system comprising:
an input module capable of inputting test parameters;
a control module comprising a micro controller, the micro controller capable of outputting power on or off control signals according to the test parameters;
a switch module capable of receiving the power on or off control signals to power on or of a computer motherboard accordingly; and
a display module;
wherein the computer motherboard is capable of outputting feedback signals to the control module after powered on, and the control module is capable of displaying test results on the display module according to the feedback signals.

11. The control system of claim 10, wherein the input module comprises a plurality of button switches, the micro controller comprises a plurality of test signal input terminals, and the plurality of button switches are electronically connected to the plurality of test signal input terminals to input the test parameters.

12. The control system of claim 11, wherein the micro controller further comprises a control signal sending terminal; the switch module comprise a switch circuit, the switch circuit comprises a first triode and a photoelectric coupler; the photoelectric coupler comprises a first light-emitting unit and a first photosensitive element; the first triode base is electronically connected to the control signal sending terminal via a first resistance to receive control signals, the first triode emitter receives a DC voltage, the first triode collector is grounded via the first light-emitting unit and a second resistance; and two ends of the first photosensitive element are separately electronically connected to a voltage pin and a grounded pin of the computer motherboard.

13. The control system of claim 12, wherein the micro controller further comprises a feedback signal receiving terminal, the switch module further comprises a feedback circuit; the feedback circuit comprises a first diode, a second diode and a second photoelectric coupler; the second photoelectric coupler comprises a second light-emitting unit and a second photosensitive element; the first diode anode is electronically connected to the computer motherboard anode pin, the first diode cathode is electronically connected to the second diode anode via the second light-emitting unit; the second diode cathode is electronically connected to the computer motherboard anode pin; and the second photosensitive element is electronically connected to the feedback signal receiving terminal

14. The control system of claim 13, wherein the feedback circuit further comprise a third diode and a fourth diode; the third diode anode is electronically connected to the computer motherboard anode pin, the third diode cathode is electronically connected to the fourth diode anode via the second light-emitting diode; and the fourth diode cathode is electronically connected to the computer motherboard cathode pin.

15. The control system of claim 14 further comprises an indication module, the indication module further comprises a second triode and a light-emitting diode; the second triode base is grounded via the second photoelectric coupler, and the second triode emitter receives the DC voltage, the second triode collector is grounded via the light-emitting diode.

16. The control system of claim 15 further comprises a alarm module, the alarm module comprises a third triode and a buzzer; the micro controller further comprises a alarm signal output terminal; the third triode base is electronically connected to the alarm signal output terminal, and the third triode emitter receives the DC voltage via the buzzer and a collector of that is grounded.

17. The control system of claim 16, wherein the micro controller further comprises a plurality of data signal output terminals; the display module comprises a liquid crystal display panel, the liquid crystal display panel comprises a plurality of data signal input terminals, and each of the plurality of data signal output terminals is electronically connected to each of the plurality of data signal input terminals to output test result.

18. The control system of claim 17, wherein the display module further comprises a backlight control circuit; the backlight control circuit comprises a fourth triode, the micro controller further comprises a backlight control signal output terminal, the liquid crystal display panel further comprises a backlight control signal input terminal; the fourth triode base is electronically connected to the backlight control signal output terminal, the fourth triode emitter receives the DC voltage, and the fourth triode collector is electronically connected to the backlight control signal input terminal.
